(19) United States
(12) Patent Application Publication
(10) Pub. No.: US 2008/0155092 A1
(43) Pub. Date: Jun. 26, 2008

(54) Method, apparatus and system for securely metering resource usage on a computing platform

(76) Inventors: Arvind Kumar, Beaverton, OR (US); Alok Prakash, Beaverton, OR (US); Sushil Patel, Campbell, CA (US)

Correspondence Address: INTEL CORPORATION;c/o INTELLEVATE, LLC, P.O. BOX 52050, MINNEAPOLIS, MN, 55402, US

(21) Appl. No.: 11/644,703

(22) Filed: Dec. 22, 2006

(51) Int. Cl. G06F 9/46; G06F 15/173

(52) U.S. Cl. 709/224; 718/100

(57) ABSTRACT

A method, apparatus and system for securely metering resource usage on a computing platform. Specifically, in one embodiment, various hardware metering counters on the device may provide a secure processing partition with usage information to enable the resources to be metered within the secure partition.

### BACKGROUND

Enterprise information technology (“IT”) and data center infrastructures today typically rely on software agents for metering various resources. The information garnered from these software agents may then be utilized to determine resource charges (“chargebacks”) to various individuals, groups, organizations and/or corporations. A prime example of an environment in which metering and/or chargeback is critical is a grid computing environment. Grid computing supports transparent sharing, selection, and aggregation of distributed resources, offering consistent and inexpensive access of the resources to grid users. By providing access to the aggregate computing power and virtualized resources of participating networked computers, grid computing enables the utilization of temporarily unused computational resources in various types of networks (e.g., massive corporate networks containing numerous idle resources). This temporary “loaning” of computational resources requires careful metering in order for the owners of the resources to accurately chargeback the resource utilization to the grid users.

One downside of using software agents for metering resources is that these agents may be manipulated or tampered with by users, which may in turn affect accurate metering. As illustrated in FIG. 1, Metering Software Agent 150 is typically an application running on Host 100, i.e., the application typically runs on Operating System (“OS”) 125, which in turn runs on Host 100's hardware (“Hardware 175”). Metering Software Agent 150 is thus vulnerable to any of the variety of attacks on OS 125 as well as direct tampering with the agent. As metering and chargeback schemes become increasingly common in IF and data center environments, this vulnerability of Metering Software Agent 150 may result in significant loss of security and/or income for various organizations and/or corporations.

### BRIEF DESCRIPTION OF THE DRAWINGS

The present invention is illustrated by way of example and not limitation in the figures of the accompanying drawings in which like references indicate similar elements, and in which:

FIG. 1 illustrates a typical metering environment;

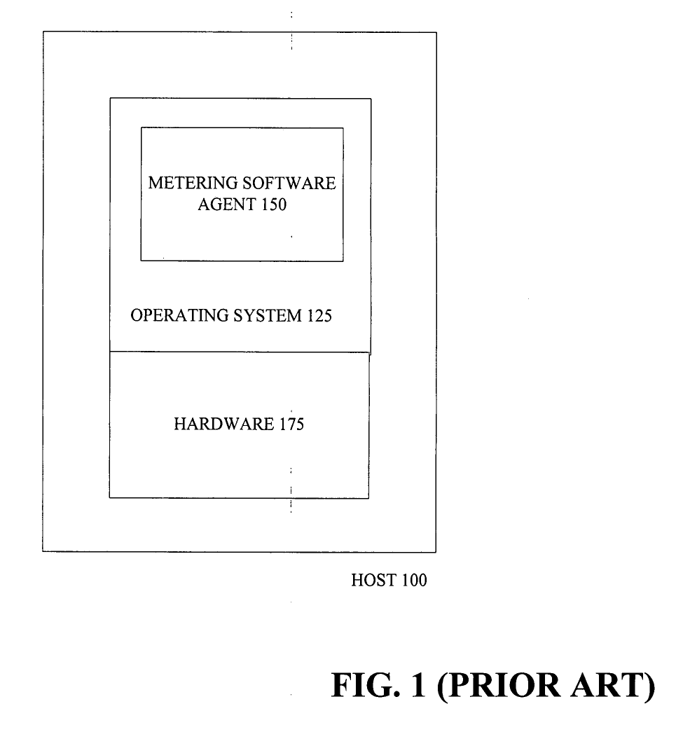

FIG. 2 illustrates an example Intel® Corporation's Active Management Technologies (“AMT”) environment;

FIG. 3 illustrates an example virtual machine host;

FIG. 4 illustrates conceptually the components of an embodiment of the present invention; and

FIG. 5 is a flow chart illustrating an embodiment of the present invention.

### DETAILED DESCRIPTION

Embodiments of the present invention provide a method, apparatus and system for securely metering resource usage on a computing platform. Although the following description assumes that the metering is being performed by one or more remotes servers coupled to one or more clients, embodiments of the invention are not so limited. Instead, the use of the term “computing platform” herein shall include any networked and/or standalone computing devices. Thus, for example, in addition to metering resource usage on remote computing devices, embodiments of the present invention may also be utilized by a standalone device to meter resource usage by various applications. Reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

According to an embodiment of the present invention, a computing platform may be enhanced to securely and accurately meter resource usage. In one embodiment, modifications may be made to the platform hardware to work in conjunction with an isolated and secure partition on the platform to perform resource metering. Embodiments of the invention support a variety of secure partition types. The common thread amongst these partition types includes the ability to maintain a strict separation between partitions, either physically or virtually. Thus, for example, in one embodiment, the partitions may be implemented by embedded processors, e.g., Intel® Corporation's Active Management Technologies (“AMT”), “Manageability Engine” (“ME”), Platform Resource Layer (“PRL”) and/or other comparable or similar technologies. In an alternate embodiment, the partitions may be virtualized, e.g., virtual machines (VM) in Intel® Corporation's Virtualization Technology (“VT”) scheme, running on a Virtual Machine Monitor (VMM) on the platform. In yet another embodiment, on a multi-core platform such as Intel® Corporation's Core 2 Duo®, a partition may comprise one of the many cores that exist on the platform. In multi-core architectures such as the Core 2 Duo®, each core may have its independent address boundary and execution, and partition isolation may be provided by the platform hardware. It will be apparent to those of ordinary skill in the art that a virtualized host may also be used to interact with and/or leverage services provided by AMT, ME and PRL technologies.

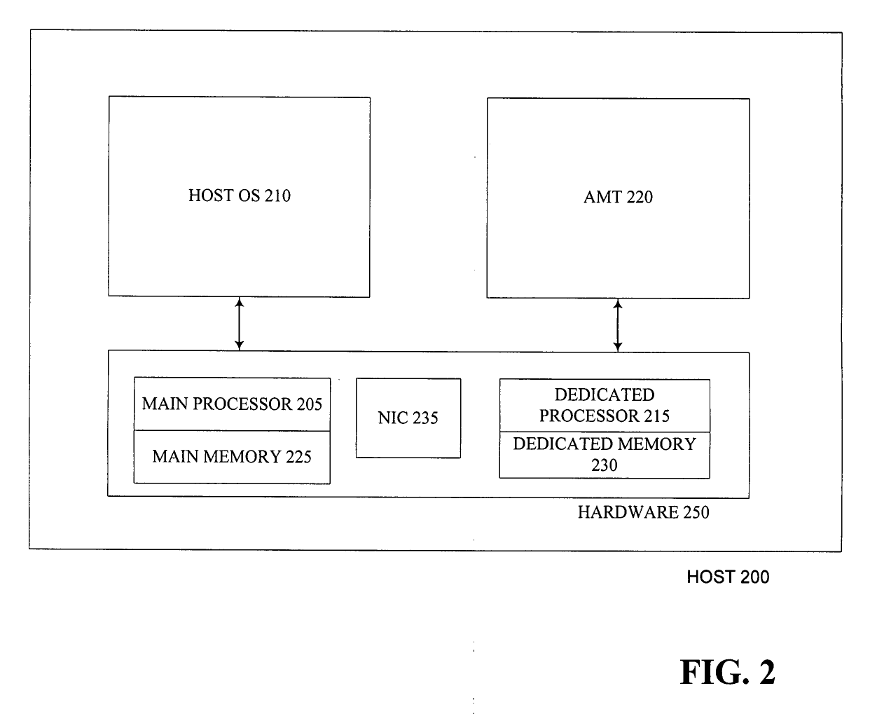

To facilitate understanding of embodiments of the present invention, the following paragraphs describe a typical AMT environment as well as a typical virtualized host. By way of example, FIG. 2 illustrates conceptually a typical Intel® AMT environment as implemented by Intel® Corporation. It will be readily apparent to those of ordinary skill in the art that embodiments of the present invention may also be implemented in other similar and/or comparable implementations of AMT. Only the components pertinent to describing the AMT environment have been illustrated in order not to unnecessarily obscure embodiments of the present invention, but it will be readily apparent to those of ordinary skill in the art that additional components may be included without departing from the spirit of embodiments of the invention.

Thus, as illustrated in FIG. 2, a device (“Host 200”) may include a host operating system (“Host OS 210”) and system hardware (“Hardware 250”). According to one embodiment, Hardware 250 may include one, two or more processors, one or more to perform typical processing tasks for Host OS 210 (“Main Processor 205”) while the other may be dedicated exclusively to managing the device via a dedicated partition (“Dedicated Processor 215” for “AMT 220”). Each processor may have associated resources on Host 200 and they may share one or more other resources. Thus, as illustrated in this example, Main Processor 205 and Dedicated Processor 210 may each have portions of memory dedicated to them (“Main Memory 225” and “Dedicated Memory 230” respectively) but they may share a network interface card (“WNIC 235”).

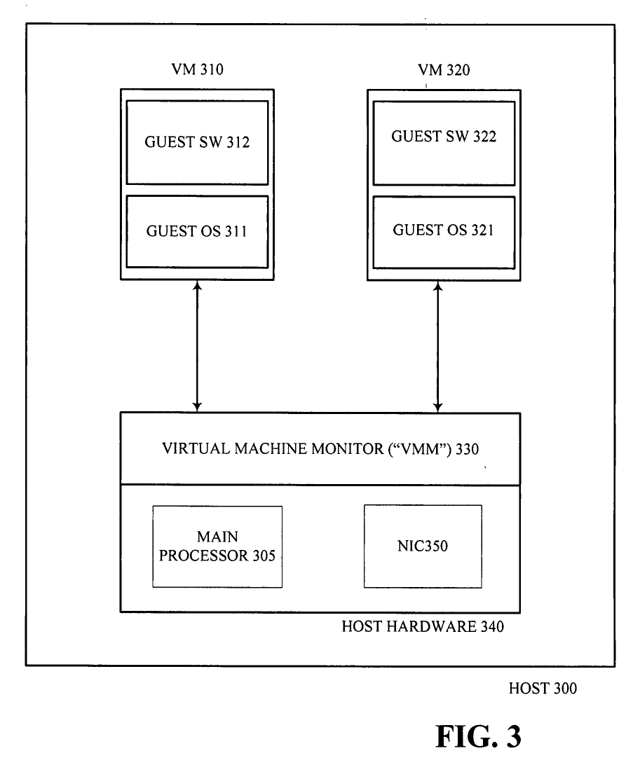

Similarly, as illustrated in FIG. 3, if device (“Host 300”) is virtualized, it may include only a single processor but a virtual machine monitor (“VMM 330”) on the device may present multiple abstractions and/or views of the device or host, such that the underlying hardware of the host appears as one or more independently operating virtual machines (“VMs”). VMM 330 may be implemented in software (e.g., as a standalone program and/or a component of a host operating system), hardware, firmware and/or any combination thereof. VMM 330 manages allocation of resources on the host and performs context switching as necessary to cycle between various VMs according to a round-robin or other predetermined scheme. It will be readily apparent to those of ordinary skill in the art that although only one processor is illustrated (“Main Processor 305”), embodiments of the present invention are not so limited and multiple processors or processor cores may also be utilized within a virtualized environment.

Although only two VM partitions are illustrated (“VM 310” and “VM 320”, hereafter referred to collectively as “VMs”), these VMs are merely illustrative and additional virtual machines may be added to the host. VM 310 and VM 320 may function as self-contained platforms respectively, running their own “guest operating systems” (i.e., operating systems hosted by VMM 330, illustrated as “Guest OS 311” and “Guest OS 321” and hereafter referred to collectively as “Guest OS”) and other software (illustrated as “Guest Software 312” and “Guest Software 322” and hereafter referred to collectively as “Guest Software”).

Each Guest OS and/or Guest Software operates as if it were running on a dedicated computer rather than a virtual machine. That is, each Guest OS and/or Guest Software may expect to control various events and have access to hardware resources on Host 100. Within each VM, the Guest OS and/or Guest Software may behave as if they were, in effect, running on Host 300's physical hardware (“Host Hardware 340”, which may include a Network Interface Card (“WNIC 350”)).

It will be readily apparent to those of ordinary skill in the art that an AMT, ME or PRL scheme may also be implemented within a virtualized environment. For example, VM 320 may be dedicated as an AMT partition on a host while VM 310 runs user applications on the host. In this scenario, the host may or may not include multiple processors. If the host does include two processors, for example, VM 320 may be assigned Dedicated Processor 215 while VM 310 (and other VMs on the host) may share the resources of Main Processor 205. On the other hand, if the host includes only a single processor, the processor may serve both the VMs, but VM 320 may still be isolated from the other VMs on the host with the cooperation of VMM 330. For the purposes of simplicity, embodiments of the invention are described in a virtualized AMT environment, but embodiments of the invention are not so limited. Instead, any reference to a “partition”, a secure partition”, a “security partition” and/or a “management partition” shall include any physical and/or virtual partition (as described above).

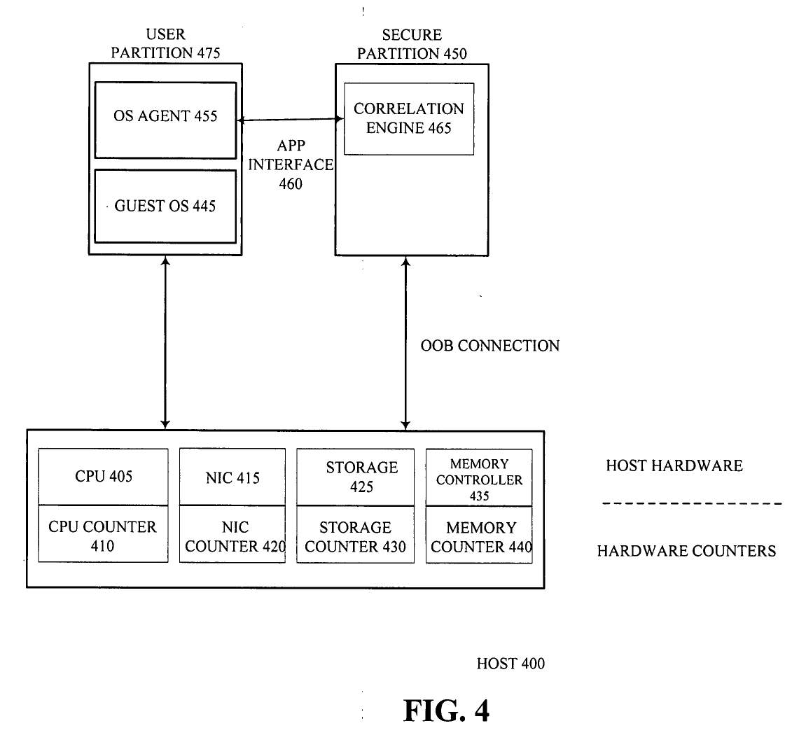

FIG. 4 illustrates an embodiment of the present invention. It will be readily apparent to those of ordinary skill in the art that only the components relevant to the invention are illustrated herein, but that other components may also be present without departing from the sprit of embodiments of the invention. As illustrated, Host 400 may include usage metering counters embedded in the central processing unit (“CPU”), the network component, the storage component and the memory component (illustrated as CPU Counter 410 in CPU 405, Network Counter 420 in Network Interface Card (“NIC”) 415, Storage Counter 430 in Storage 425 and Memory Counter 440 in Memory Controller 435 (the hardware components hereafter collectively referred to as “Host Hardware” and the counters hereafter collectively referred to as “Hardware Metering Counters”). Although four Hardware Metering Counters are illustrated in this example, embodiments of the invention are not so limited and fewer and/or more metering counters may be implemented without departing from the spirit of embodiments of the invention.

Additionally, an embodiment of the present invention includes a secure partition (“Partition 450”) capable of communicating with Host Hardware and a user partition (“User Partition 475”) also capable of communicating with Host Hardware. As previously described, the secure partition may be a virtual or physical. In the event Partition 450 is a virtual partition, User Partition 475 may comprise a VM and Host 400 may additionally include a VMM. If, however, Partition 450 is a physical (e.g., embedded) hardware partition, User Partition 475 may comprise the portion of Host 400 accessible to the user for executing applications. Regardless of the type of partition, in one embodiment, Partition 450 may be isolated from the user-accessible portion of Host 400.

User Partition 475 may include OS 445 and a software application (illustrated as “OS Agent 455”) to associate a process ID to an end-user (i.e., an application) and track a process's resource utilization. In other words, OS Agent 455 may uniquely identify each process running on Host 400 such that resource utilization on Host 400 may be traced back to a specific application. These processes may be launched by local applications (on Host 400, e.g., running within User Partition 475) or remote applications (e.g., a client coupled to Host 400, utilizing Host 400's resources to execute an application). Host 400 may also include an application interface (“App Interface 460”) that enables Partition 450 to receive identification data (e.g., userID and ProcID) from the applications executing on Host 400 and vice-versa.

In one embodiment, Host 400 may additionally include Correlation Engine 465. Correlation Engine 465 may comprise a software application capable of taking data from different sources (including the Hardware Metering Counters and/or OS Agent 430 running on Host 400) and providing comprehensive reports (described in further detail below). Correlation Engine 465 may reside within Partition 450 (as illustrated), to prevent end-user tampering but embodiments of the invention are not so limited. In an alternate embodiment, Correlation Engine 465 may run directly on OS 445.

In one embodiment of the invention, each of the Hardware Metering Counters on Host 400 may be accessible via an out-of-band (“OOB”) interface to Partition 450. As used herein, the term “out-of-band” or “OOB” includes a connection that bypasses OS 445 and enables a direct connection between the Hardware Metering Counters and Partition 450. Via this OOB connection, Partition 450 may poll the Hardware Metering Counters at predetermined intervals (the granularity of the intervals to be decided by the metering policy). In an alternate embodiment, Partition 450 may program the Hardware Metering Counters for a specific threshold. In this scenario, Partition 450 may receive notification (e.g., an interrupt) when the specified threshold is reached. In one embodiment, OS Agent 455 may additionally measure the CPU, network, storage and/or memory utilization per process using Host 400's host operating system 445 and this information may be sent to Partition 450 via App Interface 460. According to one embodiment, Correlation Engine 465 may ensure the integrity of the data received from OS Agent 455 against the information received from the Hardware Metering Counters. Correlation Engine 465 may thus compare the information received from the Hardware Metering Counters and to the information received from OS Agent 455 to ensure that they match. Any mismatch in the information may raise a flag that Host 400 may have been tampered with.

The following section describes the functionality of the Hardware Metering Counters in further detail. First, CPU Counter 410 may comprise one or more counters, where each counter may be assigned to meter processor usage for one processor core and/or one hardware thread on Host 400. Thus, for example, in a multi-core environment, each core on the host may have a separate CPU Counter 410. In one embodiment of the invention, CPU Counter 410 may comprise an uptime counter and a CPU usage counter. The uptime counter may measure the real time duration that a core and/or thread is up and running. Thus, for example, if a core is put in a “standby” or “power off” mode, the uptime counter may stop. In one embodiment, the uptime counter may comprise a hardware counter that may never be cleared. The counter may, for example, be updated at a configurable interval and the interval may be used to measure the processor uptime. In other words, if the interval is every second, the chargeback scheme would charge for every second of usage. It will be readily apparent to those of ordinary skill in the art that smaller (e.g., millisecond or microsecond) and/or larger (e.g. minute) measuring granularities may also be utilized without departing from the spirit of embodiments of the invention.

CPU Counter 410 may additionally comprise a CPU usage counter. In one embodiment, CPU usage counters may be implemented with sub-counters. Thus, utilizing the instruction counter on the host (i.e., the hardware counter that is incremented as instructions pass through the instruction pipeline), the CPU usage counter may be incremented according to a predetermined policy (e.g., every time the instruction counter reaches a specified count (e.g., a billion)). The instruction counter may then reset itself and repeat the process. The CPU usage counter may thus store the CPU usage in terms of the number of instructions executed by a thread and/or a core. In one embodiment, an idle instruction filter may be implemented for the instruction counter, thereby eliminating the usage count caused during the idle cycles. In other words, when the thread and/or core are idle, the CPU usage counter may stop altogether and resume when the thread and/or core are active again.

In one embodiment, Network Counter 420 may be implemented in the network controller (NIC 415). It is well known in the art that NIC 415 include various conceptual layers: an upper network layer, a media access and control layer (“MAC layer”) and a physical layer (“PHY layer”). In one embodiment, hardware filters in the MAC layer of NIC 415 may be utilized as counters to keep track of the network traffic on Host 400. Specifically, as network traffic passes through the MAC layer of NIC 415, the hardware filters may be applied to the traffic and the traffic count may be incremented. In one embodiment, a simple hardware filter may simply count all network packets. In an alternate embodiment, the hardware filter may be designed to be more sophisticated (e.g., count the packets that are coming from a specific IP address or port, or destined to a specific IP address or port).

In one embodiment, Storage Counter 430 may be implemented in a variety of storage devices, including for example, a serial advance technology attachment (“ATA”) controller (in the integrated controller hub (“ICH”)), a serial attached small computer system interface (“SCSI”) controller and/or a redundant array of independent (or inexpensive) disks (“RAID”) controller. In one embodiment, for SCSI traffic, the networking filters may also be used to measure SCSI storage traffic (i.e., traffic going into and coming out of the SCSI controller). According to embodiments of the invention, Storage Counter 430 may be used at the granularity of the system, or the at the Storage Logical Unit (“LUN”) level. In other words, if a first application is using LUN3 while other application is using LUN6, embodiments of the invention may meter each application individually.

Memory Counter 440. In one embodiment, Memory Counter 440 may be embedded in Memory Controller 435. Memory Counter 440 may count the number of times the Memory Controller is accessed and the counter value may be increased as the physical memory lines are fetched for use by the CPU instructions.

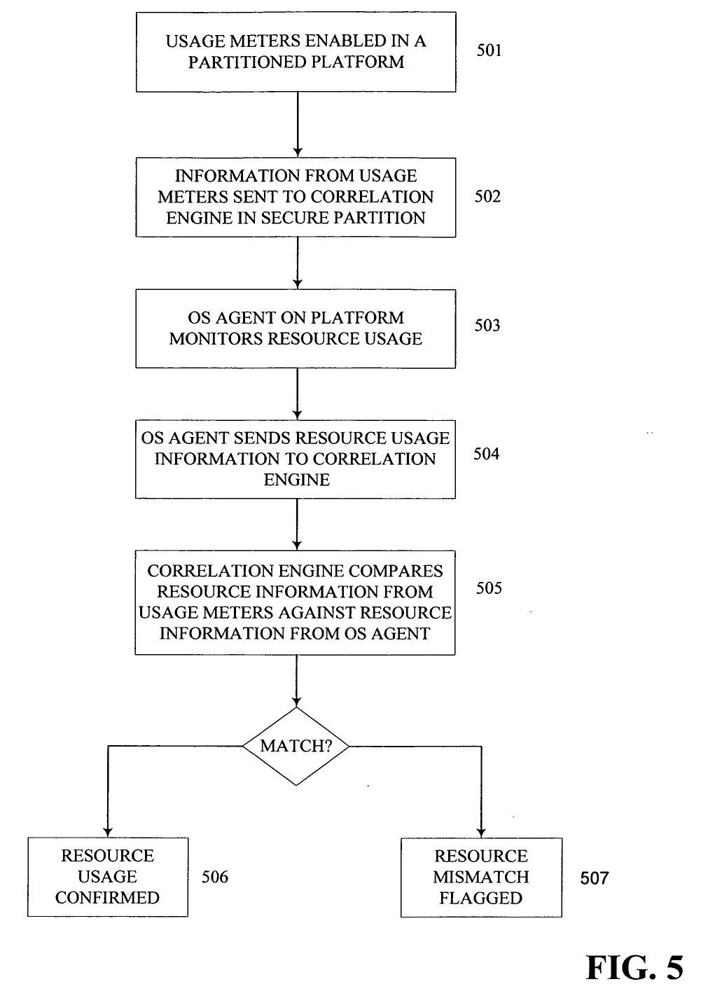

FIG. 5 is a flow chart illustrating an embodiment of the present invention. Although the following operations may be described as a sequential process, many of the operations may in fact be performed in parallel and/or concurrently. In addition, the order of the operations may be re-arranged without departing from the spirit of embodiments of the invention. In 501, usage meters may be enabled on a partitioned platform, which includes a secure partition and a user partition. In 502, information from the usage meters may be sent to a correlation engine in the secure partition (e.g., the secure partition may poll the usage meters and/or the usage meters may be configured to send out the information when predetermined thresholds are reached). An OS agent may additionally track and/or measure usage information in 503, and this usage information may be sent to a correlation engine in 504. The correlation engine in 505 may then correlate the information from the usage meters against information received from the OS agent. If the information matches, then in 506, the correlation engine may determine the correct resource usage for each application running on the platform and this resource usage may be used for a variety of reasons (e.g., chargebacks). If, however, the information does not match, then in 507, the correlation engine may raise a flag that informs the system of the mismatch.

The wireless nodes/devices according to embodiments of the present invention may be implemented on a variety of computing devices. According to an embodiment, a computing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. One or more of these elements may be integrated together with the processor on a single package or using multiple packages or dies. A host bus controller such as a Universal Serial Bus (“USB”) host controller may be coupled to the bus(es) and a plurality of devices may be coupled to the USB. For example, user input devices such as a keyboard and mouse may be included in the computing device for providing input data. In alternate embodiments, the host bus controller may be compatible with various other interconnect standards including PCI, PCI Express, FireWire and other such existing and future standards.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method comprising:
receiving in a secure partition usage data from at least one metering counter on a computing platform;
identifying a plurality of applications coupled to the computing platform;
correlating the usage data from the at least one metering counter with the plurality of applications; and
determining resource usage of each of the plurality of applications.

2. The method according to claim 1 wherein identifying a plurality of applications coupled to the computing platform further comprises:
associating a process identification with each of the plurality of applications; and
tracking the resource usage of each of the plurality of applications.

3. The method according to claim 1 wherein receiving in the secure partition the usage data from the at least one metering counter further comprises receiving in the secure partition the usage data from at least one of a central processing unit (“CPU”) metering counter, a networking metering counter, a storage metering counter and a memory metering counter.

4. The method according to claim 1 wherein receiving in the secure partition the usage data from the at least one metering counter further comprises bypassing an operating system residing on the computing platform.

5. The method according to claim 1 wherein the secure partition is one of an Active Management Technologies (“AMT”) partition, a Manageability Engine (“ME”) partition, a partition on a Platform Resource Layer (“PRL”) platform and a virtual machine (“VM”).

6. A device, comprising:
at least one hardware computing component, the at least one hardware computing component including a usage metering counter;
an agent capable of identifying a plurality of applications coupled to the at least one hardware computing component; and
a secure partition capable of receiving usage data from usage metering counter of the at least one hardware computing component and reconciling the usage data with the plurality of applications identified by the agent.

7. The device according to claim 6 further comprising a correlation engine coupled to the secure partition, the correlation engine capable of reconciling the usage data received from the usage metering counter in the at least one hardware computing component with the plurality of applications identified by the agent.

8. The device according to claim 7 wherein the correlation engine resides within the secure partition.

9. The device according to claim 6 wherein the secure partition is at least one of an Active Management Technologies (“AMT”) partition, a Manageability Engine” (“ME”), a Platform Resource Layer (“PRL”), a virtual machine (“VM”) partition and an independent processor core.

10. An article comprising a machine-accessible medium having stored thereon instructions that, when executed by a machine, cause the machine to:
receive in a secure partition usage data from at least one metering counter on a computing platform;
identify a plurality of applications coupled to the computing platform;
correlate the usage data from the at least one metering counter with the plurality of applications; and
determine resource usage of each of the plurality of applications.

11. The article according to claim 9 wherein the instructions, when executed by the machine, identify the plurality of applications coupled to the computing platform by:
associating a process identification with each of the plurality of applications; and
tracking the resource usage of each of the plurality of applications.

12. The article according to claim 9 wherein the instructions, when executed by the machine, further cause the machine to receive in the secure partition the usage data from at least one of a central processing unit (“CPU”) metering counter, a networking metering counter, a storage metering counter and a memory metering counter.

13. The article according to claim 9 wherein the instructions, when executed by the machine, further cause the machine to receive in the secure partition the usage data from the at least one metering counter by bypassing an operating system residing on the computing platform.
